(19) United States
(12) Patent Application Publication
(10) Pub. No.: US 2026/0109130 A1
(43) Pub. Date: Apr. 23, 2026

(54) LETTERING FILM WITH GOOD WEAR RESISTANCE EFFECT

(71) Applicant: Zhejiang Guangyintong New Material Technology Co., Ltd, Jinhua, Zhejiang (CN)

(72) Inventors: Wenge Zhan, Huanggang (CN); Chunrong Zhang, Jinhua (CN); Qinfen Liu, Dazhou (CN); Rui He, Yiwu (CN); Yifeng Huang, Jinhua (CN)

(21) Appl. No.: 18/924,957

(22) Filed: Oct. 23, 2024

(51) Int. Cl. B32B 3/30; B32B 3/26; B32B 5/02; B32B 7/06; B32B 7/12; B32B 9/04

(52) U.S. Cl. CPC B32B 3/30; B32B 3/266; B32B 5/024; B32B 7/06; B32B 7/12; B32B 9/04; B32B 2262/0253; B32B 2262/101; B32B 2307/554; B32B 2307/748

(57) ABSTRACT

Disclosed is a lettering film with good wear resistance effect, including a lettering film base layer and a hot melt adhesive layer. An inner wear resistant layer is arranged between the lettering film base layer and the hot melt adhesive layer, and a plurality of uniformly distributed strip grooves are arranged on a side surface of the inner wear resistant layer close to the hot melt adhesive layer; and an outer side surface of the hot melt adhesive layer is adhered to wear resistant ring members, and a bottom surface of the wear resistant ring member is arranged with a plurality of uniformly distributed strip grooves. The present disclosure can not only improve the wear resistance effect, but also has the advantages of high structural stability, good ventilation effect and convenient use.

### TECHNICAL FIELD

The present disclosure relates to lettering film, and in particular to a lettering film with good wear resistance effect.

### BACKGROUND

Lettering film, an “intermediary” for transferring patterns, is a special functional printing film that separated from a carrier film together with a release layer under the joint action of heat and pressure and is firmly transferred to the surface of a substrate. It is widely applied in various textile fabrics such as clothing, bags and shoes. However, when the lettering film is actually used, because it is adhered to the textile fabric through a hot melt adhesive layer, once it is rubbed and washed for many times, the hot melt adhesive layer will be worn under the contact of external friction and water, thereby affecting the wear resistance effect of the overall lettering film. Therefore, the existing lettering film has a problem of poor wear resistance effect.

### SUMMARY

An object of the present disclosure is to provide a lettering film with good wear resistance effect. The present disclosure has the advantage of good wear resistance effect.

The present disclosure provides the following technical solutions. A lettering film with good wear resistance effect includes a lettering film base layer and a hot melt adhesive layer. An inner wear resistant layer is arranged between the lettering film base layer and the hot melt adhesive layer, and a plurality of uniformly distributed strip grooves are arranged on a side surface of the inner wear resistant layer close to the hot melt adhesive layer; an outer side surface of the hot melt adhesive layer is adhered to wear resistant ring members, and a bottom surface of the wear resistant ring member is arranged with a plurality of uniformly distributed strip grooves; and a release layer is adhered to a side surface of the hot melt adhesive layer away from the inner wear resistant layer. The inner wear resistant layer and the wear resistant ring members can perform all-aspect wear-resistant protection on the whole hot melt adhesive layer after the heat transfer printing, and the wear resistance of the overall lettering film is improved; and a plurality of uniformly distributed strip grooves are arranged on bottom surfaces of the inner wear resistant layer and the wear resistant ring members, and the strip grooves can not only increase the area of the hot melt adhesive layer to improve the adhesive effect of the overall lettering film, but also enhance the stability of the structure.

In the aforementioned lettering film with good wear resistance effect, the wear resistant ring member is woven from long filament glass fiber and short filament polypropylene fiber.

In the aforementioned lettering film with good wear resistance effect, a ventilation ring member is arranged between the inner wear resistant layer and the wear resistant ring member, and the ventilation ring member is arranged with a plurality of uniformly distributed ventilation holes. The ventilation holes on the ventilation ring members make the overall lettering film have a certain ventilation effect. The ventilation holes on the ventilation ring ventilation are produced by punching.

In the aforementioned lettering film with good wear resistance effect, an outer wear resistant layer is adhered to a side surface of the lettering film base layer away from the hot melt adhesive layer. The outer wear resistant layer and the inner wear resistant layer can perform all-aspect wear-resistant protection on the lettering film base layer, thereby improving the wear resistance of the lettering film base layer.

In the aforementioned lettering film with good wear resistance effect, the outer wear resistant layer and the inner wear resistant layer are both made of silicon dioxide material.

In the aforementioned lettering film with good wear resistance effect, a brace is fixedly mounted on a side surface of the release layer. The release layer can be easily separated from the hot melt adhesive layer by using the brace, which is convenient for use.

Compared with the prior art, the present disclosure improves the prior lettering film, by arranging the inner wear resistant layer between the lettering film base layer and the hot melt adhesive layer, the wear resistant ring members are adhered to an outer surface of the hot melt adhesive layer, and the inner wear resistant layer and the wear resistant ring members can perform all-aspect wear-resistant protection on the whole hot melt adhesive layer after heat transfer printing, thereby reducing the wear of the hot melt adhesive layer and improving the wear resistance of the overall lettering film. At the same time, a plurality of uniformly distributed strip grooves are arranged on bottom surfaces of the inner wear resistant layer and the wear resistant ring members, and the strip grooves can not only increase the area of the hot melt adhesive layer, to improve the adhesive effect of the overall lettering film. Moreover, the strip groove can also increase the friction between the inner wear resistant layer and the hot melt adhesive layer, thereby increasing the stability of the connection between the inner wear resistant layer and the hot melt adhesive layer, and improving the stability of the whole structure. In addition, the present disclosure also arranges the wear resistant ring members to be woven by long filament glass fiber and short filament polypropylene fiber, so that the internal stress of the wear resistant ring members is minimized, the overall structure is more compact, the wear resistance ability of the wear resistant ring members can be improved and the wear resistance effect can be further improved. The ventilation ring members are arranged between the inner wear resistant layer and the wear resistant ring members, the plurality of uniformly distributed ventilation holes are arranged on the ventilation ring members, and the ventilation holes on the ventilation ring members make the overall lettering film have a certain ventilation effect. By adhering the outer wear resistant layer on a top surface of the lettering film base layer, the outer wear resistant layer and the inner wear resistant layer can perform all-aspect wear-resistant protection on the lettering film base layer, thereby improving the wear resistance ability of the lettering film base layer and further improving the wear resistance effect of the overall lettering film. By mounting the brace on the side surface of the release layer, the release layer and the hot melt adhesive layer can be conveniently separated by the brace, which is convenient for use. Therefore, the present disclosure can not only improve the wear resistance effect, but also has the advantages of high structural stability, good ventilation effect and convenient use.

### BRIEF DESCRIPTION OF THE DRAWINGS

FIG. 1 is a schematic structural diagram of the present disclosure; and

FIG. 2 is a side view of the present disclosure.

Reference numerals and denotations thereof: 1—lettering film base layer, 2—hot melt adhesive layer, 3—inner wear resistant layer, 4—strip groove, 5—wear resistant ring member, 6—release layer, 7—ventilation ring member, 8—ventilation hole, 9—outer wear resistant layer, and 10—brace.

### DETAILED DESCRIPTION

The present disclosure will be further described with reference to the attached drawings and examples, but it is not taken as a basis for limiting the present disclosure.

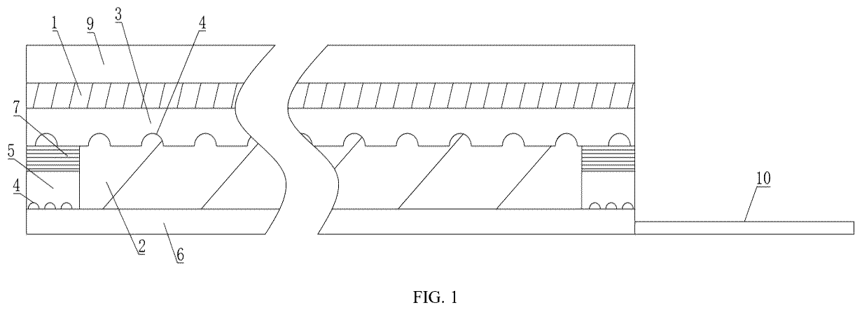

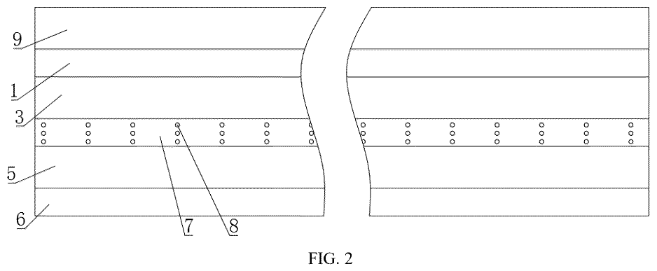

Example 1: A lettering film with good wear resistance effect, as shown in FIGS. 1 and 2, includes a lettering film base layer 1 and a hot melt adhesive layer 2. An inner wear resistant layer 3 is arranged between the lettering film base layer 1 and the hot melt adhesive layer 2, and a plurality of uniformly distributed strip grooves 4 are arranged on a side surface of the inner wear resistant layer 3 close to the hot melt adhesive layer 2; an outer side surface of the hot melt adhesive layer 2 is adhered to wear resistant ring members 5, and a bottom surface of the wear resistant ring member 5 is arranged with a plurality of uniformly distributed strip grooves 4; and a release layer 6 is adhered to a side surface of the hot melt adhesive layer 2 away from the inner wear resistant layer 3.

The wear resistant ring member 5 is woven from long filament glass fiber and short filament polypropylene fiber; a ventilation ring member 7 is arranged between the inner wear resistant layer 3 and the wear resistant ring member 5, and the ventilation ring member 7 is arranged with a plurality of uniformly distributed ventilation holes 8; an outer wear resistant layer 9 is adhered to a side surface of the lettering film base layer 1 away from the hot melt adhesive layer 2; the outer wear resistant layer 9 and the inner wear resistant layer 3 are both made of silicon dioxide material; and a brace 10 is fixedly mounted on a side surface of the release layer 6.

Example 2: A lettering film with good wear resistance effect, as shown in FIGS. 1 and 2, includes a lettering film base layer 1 and a hot melt adhesive layer 2. An inner wear resistant layer 3 is arranged between the lettering film base layer 1 and the hot melt adhesive layer 2, and a plurality of uniformly distributed strip grooves 4 are arranged on a side surface of the inner wear resistant layer 3 close to the hot melt adhesive layer 2; an outer side surface of the hot melt adhesive layer 2 is adhered to wear resistant ring members 5, and a bottom surface of the wear resistant ring member 5 is arranged with a plurality of uniformly distributed strip grooves 4; and a release layer 6 is adhered to a side surface of the hot melt adhesive layer 2 away from the inner wear resistant layer 3.

The wear resistant ring member 5 is woven from long filament glass fiber and short filament polypropylene fiber; a ventilation ring member 7 is arranged between the inner wear resistant layer 3 and the wear resistant ring member 5, and the ventilation ring member 7 is arranged with a plurality of uniformly distributed ventilation holes 8; an outer wear resistant layer 9 is adhered to a side surface of the lettering film base layer 1 away from the hot melt adhesive layer 2; the outer wear resistant layer 9 and the inner wear resistant layer 3 are both made of silicon dioxide material; and a brace 10 is fixedly mounted on a side surface of the release layer 6. The strip grooves 4 on the inner wear resistant layer 3 and the wear resistant ring members 5 can be produced by laser cutting or mold pressing.

The working principle is as follows. In the process of using the lettering film, the release layer 6 is removed from the hot melt adhesive layer 2 by the brace 10, and patterns are engraved on the outer wear resistant layer 9, the lettering film base layer 1, the hot melt adhesive layer 2 and the inner wear resistant layer 3 by using the lettering machine; and the overall lettering film is adhered to the textile fabric through the hot melt adhesive layer 2 and pressed and heated, so that the hot melt adhesive layer 2 can be stably adhered to the textile fabric. Because the outer periphery of the hot melt adhesive layer 2 is arranged with the wear resistant ring members 5, and the inner wear resistant layer 3 is arranged between the hot melt adhesive layer 2 and the lettering film base layer 1, so that the inner wear resistant layer 3 and the wear resistant ring members 5 can comprehensively protect the periphery of the hot melt adhesive layer 2, the phenomenon of damage of the hot melt adhesive layer 2 caused by multiple washing friction is avoided, and the overall lettering film can be adhered to the textile fabric for a longer time and stably, thereby improving the wear resistance effect of the overall lettering film. Moreover, because the inner wear resistant layer 3 and the strip grooves 4 on the wear resistant ring members 5 are arranged, a friction coefficient between the inner wear resistant layer 3 and the hot melt adhesive layer 2 can be increased, and the fluidity between the hot melt adhesive layer 2 and the inner wear resistant layer 3 can be reduced, so that the phenomenon of offset between the inner wear resistant layer 3 and the hot melt adhesive layer 2 can be avoided in the process of hot pressing, thereby ensuring the heat transfer printing effect. At the same time, the ventilation effect of the overall lettering film can be improved by matching the ventilation holes 8 on the ventilation ring members 7 between the wear resistant ring members 5 and the inner wear resistant layer 3. The outer wear resistant layer 9 can perform wear-resistant protection on the lettering film base layer 1 on the outside, thereby further improving the wear resistance effect of the overall lettering film.

1. A lettering film with good wear resistance effect, comprising a lettering film base layer (1) and a hot melt adhesive layer (2), wherein an inner wear resistant layer (3) is arranged between the lettering film base layer (1) and the hot melt adhesive layer (2), and a plurality of uniformly distributed strip grooves (4) are arranged on a side surface of the inner wear resistant layer (3) close to the hot melt adhesive layer (2); an outer side surface of the hot melt adhesive layer (2) is adhered to wear resistant ring members (5), and a bottom surface of the wear resistant ring member (5) is arranged with a plurality of uniformly distributed strip grooves (4); and a release layer (6) is adhered to a side surface of the hot melt adhesive layer (2) away from the inner wear resistant layer (3).

2. The lettering film with good wear resistance effect according to claim 1, wherein the wear resistant ring member (5) is woven from long filament glass fiber and short filament polypropylene fiber.

3. The lettering film with good wear resistance effect according to claim 1, wherein a ventilation ring member (7) is arranged between the inner wear resistant layer (3) and the wear resistant ring member (5), and the ventilation ring member (7) is arranged with a plurality of uniformly distributed ventilation holes (8).

4. The lettering film with good wear resistance effect according to claim 1, wherein an outer wear resistant layer (9) is adhered to a side surface of the lettering film base layer (1) away from the hot melt adhesive layer (2).

5. The lettering film with good wear resistance effect according to claim 4, wherein the outer wear resistant layer (9) and the inner wear resistant layer (3) are both made of silicon dioxide material.

6. The lettering film with good wear resistance effect according to claim 1, wherein a brace (10) is fixedly mounted on a side surface of the release layer (6).

7. The lettering film with good wear resistance effect according to claim 2, wherein a brace (10) is fixedly mounted on a side surface of the release layer (6).

8. The lettering film with good wear resistance effect according to claim 3, wherein a brace (10) is fixedly mounted on a side surface of the release layer (6).

9. The lettering film with good wear resistance effect according to claim 4, wherein a brace (10) is fixedly mounted on a side surface of the release layer (6).

10. The lettering film with good wear resistance effect according to claim 5, wherein a brace (10) is fixedly mounted on a side surface of the release layer (6).
